(19) United States
(12) Patent Application Publication
(10) Pub. No.: US 2009/0288091 A1
(43) Pub. Date: Nov. 19, 2009

(54) Method and System Integrating Task Assignment and Resources Scheduling

(76) Inventor: Nikolaos Papadakos, London (GB)

Correspondence Address: NIKOLAOS PAPADAKOS, 20 PURCESS CRESCENT, LONDON, SW6 7PB, GB

(21) Appl. No.: 12/120,653

(22) Filed: May 15, 2008

(51) Int. Cl. G06F 9/50; G06F 9/46

(52) U.S. Cl. 718/104

(57) ABSTRACT

A method and a system for integrating and solving simultaneously both task assignment and resources scheduling decision making problems, thereby providing an overall feasible and optimal solution. The method and the system may be used for integrated airline scheduling in which case the task assignment is fleet assignment, and the resources scheduling are aircraft routing with maintenance (maintenance routing) and crew scheduling (or crew pairing only). In a preferred embodiment, Benders decomposition is employed with Pareto-optimal cuts, where the Benders subproblem solution is sped-up without influencing Pareto-optimal cut generation. The cost savings achieved in comparison with traditional methods are estimated, so that the user can terminate the solution process when these cost savings are satisfactory enough. Important properties of the solution are stored enabling the user to efficiently re-solve the problem even in cases where it is different from the initial one.

### CROSS-REFERENCE TO RELATED APPLICATIONS

This application claims the benefit of provisional patent application Ser. No. 60/917,803, filed on May 14, 2007 by the present inventor.

### FEDERALLY SPONSORED RESEARCH

Not Applicable.

### SEQUENCE LISTING OR PROGRAM

Not Applicable.

### BACKGROUND OF THE INVENTION

A. Field of the Invention

The present invention generally relates to decision support systems, and more specifically to a system providing integrated task assignment decisions and resources scheduling decisions, wherein said decisions are overall feasible and overall optimal.

B. Description of the Related Art

Task assignment and resources scheduling have various applications in different fields, to name a few: in airlines, in railways, in shipping, or in military mission deployment.

For some applications an overall decision making problem needs to be solved, comprising three individual decision making problems: a task assignment, a vehicle routing, and a crew timetabling (also known as crew scheduling). These three decision making problems are usually solved by a sequential system, comprising three individual systems, one for each individual decision making problem, namely: a task assignment system, a vehicle routing system, and a crew timetabling system. For example, see U.S. Pat. No. 6,076,067 to Jacobs et al. (2000), U.S. Pat. No. 6,314,361 to Yu et al. (2001), U.S. Pat. No. 6,408,276 to Yu et al. (2002), U.S. Pat. No. 6,721,714 to Baiada et al. (2004), U.S. Pat. No. 7,006,903 to Smith et al. (2006), U.S. Pat. No. 7,191,140 to Yu et al. (2007), U.S. Pat. No. 7,228,207 to Clarke et al. (2007), and U.S. Pat. No. 7,340,405 to Günther et al. (2008). See also the following publications and the references therein contained:
Barnhart, C., Boland, N., Clarke, L., Johnson, E., Nemhauser, G., and Shenoi, R. (1998a). Flight string models for aircraft fleeting and routing. Transportation Science, 32(3):208-220.
Barnhart, C., Lu, F., and Shenoi, R. (1998b). Integrated airline schedule planning. In Yu, G., editor, Operations Research in the Airline Industry, pages 384-403. Kluwer, Boston.
Cohn, A. and Barnhart, C. (2003). Improving crew scheduling by incorporating key maintenance routing decisions. Operations Research, 51(3):387-396.
Cordeau, J.-F., Soumis, F., and Desrosiers, J. (2000). A Benders decomposition approach for the locomotive and car assignment problem. Transportation Science, 34(2):133-149.
Cordeau, J.-F., Soumis, F., and Desrosiers, J. (2001a). Simultaneous assignment of locomotives and cars to passenger trains. Operations Research, 49(4):531-548.
Cordeau, J.-E, Stojković, G., Soumis, E, and Desrosiers, J. (2001b). Benders decomposition for simultaneous aircraft routing and crew scheduling. Transportation Science, 35(4):375-388.
Hane, C., Barnhart, C., Johnson, E., Marsten, R., Nemhauser, G. L., and Sigismondi, G. (1995). The fleet assignment problem: solving a large-scale integer program. Mathematical Programming, 70:211-232.
Lasdon, L. (1970). Optimization Theory for Large Systems. Macmillan, London.
Magnanti, T. and Wong, R. (1981). Accelerating Benders decomposition: Algorithmic enhancement and model selection criteria. Operations Research, 29(3):464-484.
Mercier, A., Cordeau, J.-E, and Soumis, F. (2005). A computational study of Benders decomposition for the integrated aircraft routing and crew scheduling problem. Computers & Operations Research, 32(6):1451-1476.
Papadakos, N. (2006). Integrated Airline Scheduling: Models and Decomposition Techniques. PhD thesis, Imperial College London.
Papadakos, N. (2007). Integrated airline scheduling. Computers & Operations Research. doi: 10.1016/j.cor.2007.08.002.
Papadakos, N. (2008). Practical enhancements to the Magnanti-Wong method. Operations Research Letters. doi: 10.1016/j.orl.2008.01.005.
Sandhu, R. and Klabjan, D. (2004). Integrated airline planning. In Proceedings 44th AGIFORS Annual Symposium, Singapore, Singapore.

The above mentioned sequential system partitions the overall decision making problem, and solves each individual decision making problem one after the other, so that: the solution of the task assignment system is the input of the vehicle routing system, and the solution of the latter system is in its turn the input of crew timetabling system. In case the goal of the overall decision making problem is to minimize the costs, with the sequential system one finds the minimum cost of each individual decision making problem, which when summed might be worse than the overall optimal solution, due to their interdependence. Moreover, there might be cases where some constraints are not mutually satisfied, for instance the solution of the task assignment decision making problem might lead to vehicle routing decision making problems where it is not possible to satisfy the maintenance routing constraints (Barnhart et al., 1998a, Papadakos, 2006).

For these reasons, there have been attempts to partially integrate the optimization of two of the above decision making problems within a single decision making problem. Barnhart et al. (1998a) integrated task assignment with vehicle routing, and Cordeau et al. (2001b), Cohn and Barnhart (2003), and Mercier et al. (2005) integrated vehicle routing with crew timetabling. Sandhu and Klabjan (2004) integrated task assignment with crew timetabling, and used Benders decomposition without the method of Magnanti and Wong (1981). The method of Magnanti and Wong generates Pareto-optimal cuts instead of Benders cuts, and typically requires:
a Benders master problem core point (a point x ε X is a core point if x ε ri (X^{c}), where ri (X) and X^{c} are respectively the relative interior and the convex hull of set X), and
an optimal solution of the Benders subproblem.
   Concerning the first requirement, Sandhu and Klabjan (2004) stated that the reason they did not experiment with Pareto-optimal cuts was that it is a non trivial task to find a core point. Concerning the second requirement, it should be stressed that the method of Magnanti and Wong (1981) becomes numerically unbounded when supplied with a suboptimal Benders subproblem solution, for several applications (Papadakos, 2006). This prohibits one from using quickly reachable near-optimal solutions, that could speed-up the overall procedure.

Of course any of the partial integrations, discussed above, are not able to achieve an overall optimum solution. Likewise, it is not always possible to find an overall solution that satisfies simultaneously the constraints of all decision making problems. As an example, integrations like the one of Sandhu and Klabjan (2004) are unable to guarantee maintenance feasibility, as they state themselves and was also proved in practice by Papadakos (2006, 2007).

Notice, that all three decision making problems have never been integrated, as it was thought that such a system would primarily face limitations in computer technology and solution algorithms (Barnhart et al., 1998b).

Finally, notice that Sandhu and Klabjan (2004) reported poor results when they employed Benders decomposition for the integrated task assignment with crew timetabling decision making problem, and stated that a combination of Lagrangian relaxation and column generation is more robust and practical.

### SUMMARY OF THE INVENTION

The present invention aims to obviate or reduce the above mentioned problems. More specifically, it integrates task assignment and resources scheduling decisions within a single decision support system.

One embodiment of the present invention provides a computer-implemented method for integrated task assignment decisions and resources scheduling decisions, comprising: (a) deciding an assignment of a task to each of the said resources based on a set of constraints, (b) for each scheduled resource, deciding a schedule of the said scheduled resource based on a given task assignment decision, on a given schedule decision for each of the other resources the said scheduled resource may depend on, and on a set of constraints, and (c) computing an integrated decision comprising: a decision for the assignment of a task to each of the said resources, wherein no constraints are violated, for each scheduled resource, a decision of the schedule of the said scheduled resource that was based on the said integrated decision's: task assignment decision, and scheduling decision of the resources that the said scheduled resource depends on, wherein, if any constraints are violated, making different decisions on some or all of the following: the tasks assigned, the resources that the said scheduled resource depends on, wherein said different decisions are made until no constraints of the said resource are violated.

One embodiment of the present invention provides a system making integrated task assignment decisions and resources scheduling decisions, to be used in a computer system, comprising: (a) means for deciding an assignment of a task to each of the said resources based on a set of constraints, (b) for each scheduled resource, means for deciding a schedule of the said scheduled resource based on a given task assignment decision, on a given schedule decision for each of the other resources the said scheduled resource may depend on, and on a set of constraints, and (c) means for computing an integrated decision comprising: a decision for the assignment of a task to each of the said resources, wherein no constraints are violated, for each scheduled resource, a decision of the schedule of the said scheduled resource that was based on the said integrated decision's: task assignment decision, and scheduling decision of the resources that the said scheduled resource depends on, wherein, if any constraints are violated, making different decisions on some or all of the following: the tasks assigned, the resources that the said scheduled resource depends on, wherein said different decisions are made until no constraints of the said resource are violated.

In a preferred embodiment Benders decomposition is employed to separate different parts of the overall integrated decision making problem, into a master problem and a subproblem. Both Benders problems are solved iteratively. The Benders master problem supplies the subproblem with a candidate solution, i.e. a possible task assignment and vehicle routing. Then in the Benders subproblem the consequences of that solution are measured, and an appropriate constraint (also known as cut) is added to the Benders master problem. The added cut prohibits the same decision to be taken in the next iteration.

In one embodiment, in order to enhance the generation of Benders cuts, the method of Magnanti and Wong (1981) generating Pareto-optimal Benders cuts, is used in every Benders iteration. In another embodiment, a method for generating the required core point approximately is given. Still in an another embodiment, a method generating the required points (which are not necessarily core points) that do not even have to be solutions of the Benders master problem, but do assist in generating Pareto-optimal cuts, is also provided. Another alternative method offers the possibility of generating Pareto-optimal cuts without the need of an optimal Benders subproblem solution.

The Benders iterations continue until a near-optimal solution is found, with a proximity that satisfies the user (i.e. solution quality acceptability). For this reason, in every iteration, a method to estimate the savings of the present system in comparison with other known methods is given.

### BRIEF DESCRIPTION OF THE DRAWINGS

The accompanying drawings are incorporated in and constitute a part of this specification, and together with the description, explain by way of example only the advantages and principles of the invention. In the drawings:

FIG. 1 is a diagram of a known sequential system making task assignment decisions, vehicle routing decisions, and crew timetabling decisions;

FIG. 2 is a diagram of the integrated system of the present invention, where the modules integrated are: a task assignment module, a vehicle routing module, and a crew timetabling module; and

FIG. 3 is a logic flow diagram of the operation of the integrated method of the present invention.

### DETAILED DESCRIPTION OF PREFERRED EMBODIMENTS

Task assignment and resources scheduling have various applications in different fields, to name a few: in airlines, in railways, in shipping, or in military mission deployment. Usually there might be different resources to schedule, for instance machines that will perform some given tasks, as well as operators of the said machines. Based on the latter example and for ease of exposition, two resources will be named from now on: vehicles and crew. The corresponding schedules will be referred to as vehicle routes and crew timetables, or simply routes and timetables. The application of the present system and method is not restrictive to these resources only, and should be viewed as if applied to any of the relevant fields. Thus, when referring to a vehicle one should interpret it as a resource R₁, and to crew as a resource R₂, that will be embodied according to the application they will be used into. Likewise a route will be the schedule of resource R₁, and a timetable will be the schedule of resource R₂. Both resources could be referring to machines, or both resources could be referring to persons, or resource R₁ could refer to a person and resource R₂ to a machine.

As an example, when applied to airlines the above mentioned task assignment corresponds to the (airline) fleet assignment, wherein flights (the corresponding tasks) are assigned to fleets of aircraft. Likewise vehicle routing corresponds to aircraft routing, or to maintenance routing (i.e. aircraft routing where maintenance constraints are taken into account). Moreover, crew time tabling corresponds to (airline) crew scheduling. Airline crew scheduling is sometimes decomposed into crew pairing and crew rostering. However, in some applications crew pairing is also simply referred to as crew scheduling.

The fleet assignment described above is not only restricted to airlines, and can for example also be applied to railways. A fleet is a set of vehicles with similar characteristics, that can be interchangeably used for the same task. For instance, in the case of airlines all aircraft of the same type with the same number of seats can be used for the same flight. Crew are usually qualified to operate several fleets, but typically not all of them. A fleet family, which will be referred to from now on simply as family, is a set of fleets than can be operated by the same crew. For instance, pilots might have a type rating to operate aircraft of certain types. The said certain aircraft types, however, might belong to different fleets, as they might have different number of seats and hence different potential for revenue generation.

A solution of a vehicle routing decision making problem for a given fleet is simply named hereafter as routing. A routing consists of several routes of different vehicles of the same fleet. Each route is a schedule of tasks a vehicle is assigned to, including perhaps additional information on how to reach and accomplish these tasks. Such route information may for instance be: the periodic visit to maintenance stations, the maintenance procedures that a vehicle has to undergo, or the trajectory the vehicle has to follow. Each routing has to obey certain constraints, for instance the maximum time a vehicle can operate without maintenance, as well as using at most the number of vehicles available. Other constraints that have to be taken into account concern the flow of the vehicles throughout the network of tasks (e.g. flights).

A solution of a crew timetabling decision making problem for a specific family is simply named hereafter as timetabling. A timetabling is made of different timetables of crew of the same family. A timetable is a series of tasks crew are assigned to accomplish while operating the vehicles. The timetables typically have to satisfy labor constraints, crew availability, and personal preferences. Other constraints that have to be taken into account concern the flow of the crew throughout the network of tasks (e.g. flights).

A solution of a task assignment decision making problem (e.g. fleet assignment) is the decision made by the corresponding task assignment decision making system (or task assignment decision making module). Likewise the solution of a resource scheduling problem (e.g. vehicle routing or crew time tabling) is the decision made by the corresponding vehicle routing decision making system (or vehicle routing decision making module).

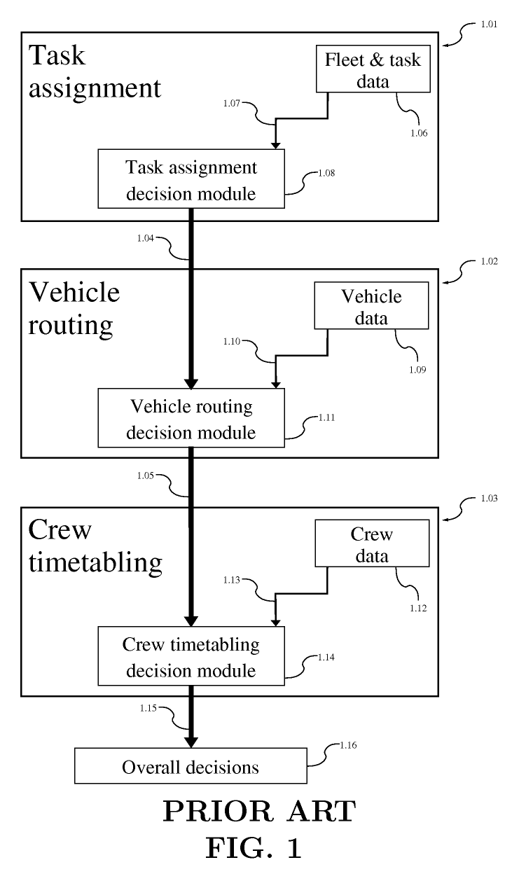

In some applications three decision making problems are solved: a task assignment, a vehicle routing, and a crew timetabling, usually by a known system depicted in FIG. 1. This system sequentially uses a task assignment system 1.01, a vehicle routing system 1.02, and a crew timetabling system 1.03, one after the other, so that the output of one is the output of the next in the sequence as depicted in FIG. 1.

The task assignment system 1.01 is comprised of a user input 1.06, by communication means 1.07, and a task assignment decision module 1.08. The vehicle routing system 1.02 is comprised of a user input 1.09, some input communication means 1.04 and 1.10, and a vehicle routing decision module 1.11. The crew timetabling system 1.03 is comprised of a user input 1.12, some input communication means 1.05 and 1.13, and a crew timetabling decision module 1.14. Finally, the overall decision is communicated by communication means 1.15 to a medium 1.16 where it is stored.

The decision modules 1.08, 1.11, and 1.14 can be comprised of dedicated computers and computer processes that solve the respective decision making problems. It is possible to have all decision modules within one computer alternatively. The data 1.06, 1.09, and 1.12 is entered by the user utilizing a computer keyboard, or a pointing selection device (i.e. computer mouse). It is also possible that some of the data are already stored in some device (i.e. CD-ROM, hard disk, another medium or memory, or another computer). All these data are supplied to the decision modules by communication means 1.07, 1.10, and 1.13, which could well be cables over a network, or in case more than one decision modules are in the same computer, internal computer communication medium and storage. The same holds for the communication means 1.04, 1.05, and 1.15. The former two communication means transfer the output data of the decisions from one decision module as the input to the next in the sequence. Finally, the decisions made are stored in the medium 1.16 (which can be a hard disk, a CD-ROM, or any other memory medium) wherefrom the user can acquire it at anytime and implement the schedules decided by the system in practice.

The known sequential system for solving the three decision making problems is hereafter described in detail, and an example of its application to airlines is given correspondingly in brackets. The user initially employs the means 1.07 to communicate the data 1.06 of fleet (aircraft type and characteristics, i.e. number of available aircraft, number of seats, speed, etc) and tasks (flights and their data, i.e. origin and destination time and station, ticket demand, etc) to the task assignment decision module 1.08. The decision module 1.08 assigns then each task to a particular fleet, while possibly optimizing some given objectives (maximize profits or minimize costs). The output of the task assignment is communicated by said means 1.04 to the vehicle routing decision module 1.11, together with user input vehicle data 1.09 (dedicated maintenance stations, regularity of maintenance, etc) communicated with said means 1.10. The output of task assignment partitions the tasks in sets of tasks that will be used by specific fleets of vehicles. Then for each fleet, and relying on the input data 1.09, the vehicle routing decision module 1.11 finds the appropriate routes for the vehicles, while possibly optimizing some given objectives (maximize through flights revenue). After this, in its turn, the output of the vehicle routing decision is communicated with said means 1.05 to the crew timetabling decision module 1.14, together with the user input 1.12 of crew data (pilots and air-hosts, type-rating, labor regulations, etc) communicated with said means 1.13. Therefore, based on the vehicle routing decisions (communicated via said means 1.05) and the labor regulations (contained in data 1.12) to operate the given routes, the crew timetabling decision module finds the appropriate crew timetables, while possibly optimizing some given objective (minimize crew costs). Notice that typically the vehicle routing decision can influence the crew timetabling decision (Mercier et al., 2005). Finally, all decisions communicated via said means 1.15 and stored in said medium 1.16, wherefrom the user recovers the decisions. These decisions are advising the user on which tasks should be assigned to each fleet, which routes each vehicle should follow, and what the timetables of crew should be. The user might make some alterations based on his experience.

In case only one of the resources scheduling problems, either vehicle routing or crew timetabling, needs not be solved, one omits the corresponding system, either 1.02 or 1.03, and connects the task assignment system and the decision storage medium 1.16 directly to the resources scheduling system required.

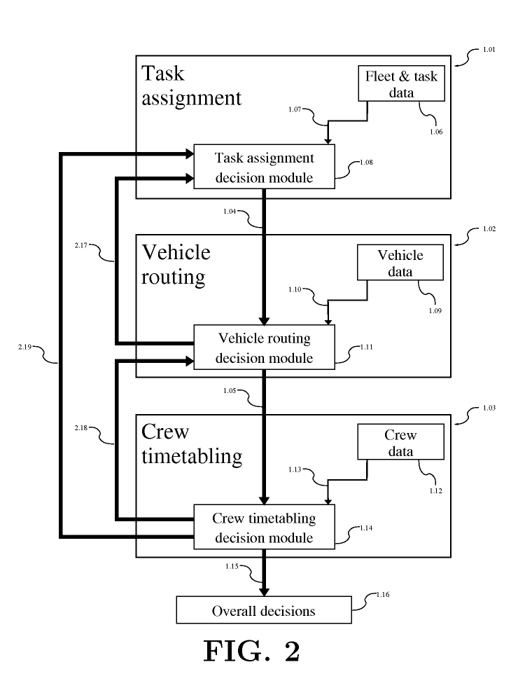

One embodiment of the present invention is an extension of the sequential system and this extension is depicted in FIG. 2. According to the previously mentioned embodiment, if the decision of the vehicle routing decision module 1.11 is not of an acceptable quality, the vehicle routing decision module communicates information to the task assignment decision module 1.08 by communication means 2.17, and then the task assignment decision module makes a decision again. Likewise, if the decision of the crew timetabling decision module 1.14 is not of an acceptable quality, the crew timetabling decision module communicates information to the task assignment decision module 1.08 by communication means 2.18 and to the vehicle routing decision module 1.11 by communication means 2.19, and then the task assignment decision module makes a decision again. In some embodiments, the quality of a decision is not acceptable if the decision made is not feasible (i.e. some or all of the constraints are violated) or if the decision made is not within an acceptable distance from the optimal decision as the user would like it to be. The information communicated via said methods 2.17, 2.18, and 2.19 is such that different decisions will be made when any of the said decision modules make decisions again.

In order to provide the mathematical model need for one embodiment, let F be the set of fleets, and T the set of families each crew can operate. Then each fleet f ε F will belong to exactly one family t ε T, and therefore one may write f ε t. Let L be the set of tasks, R^{f} the set of routings for each fleet f ε F, and P^{t} the set of timetablings for each family t ε T. The sets R^{f} will be generally distinct for each fleet (i.e. different vehicles have different speed). Hence, once known that a routing r_{f} belongs to a specific set R^{f}, the fleet subscript may be dropped and simply write r(ε R^{f}). The same generalization is assumed for each family, and hence the sets P^{t} are distinct. Thus, once known that a timetabling pₜ belongs to P^{t}, one may drop the family subscript and simply write p(ε P^{t}). Let x_{fl} be the variable counting the number of vehicles of fleet f ε F assigned to task l ε L. Similarly, let vᵣ and wₚ be the binary variables equal to one if and only if routing r ε R^{f} and timetabling p ε P^{t} are the chosen solutions. The routing is usually described by a matrix, whose components eₗᵣ are equal to the number of times routing r ε R^{f} includes task l ε L. The timetabling is usually described by a matrix, whose components aₗₚ is equal to the number of times timetabling p ε P^{t} includes task l ε L. Let cₚ the cost of timetabling p ε P^{t} for family t ε T, and c(x, v) be a function (sometimes linear) providing the cost of the given task assignment x≡(x_{fl}|∀l ε L,∀f ε F) and routing v≡(vᵣ|∀r ε R^{f},∀f ε F). Profits maybe taken into account too as negative costs. Moreover, special connections are usually considered and expressed through respective matrices. For these matrices, the components s^{ij}ᵣ and s^{ij}ₚ will be equal to the number of times a special connection between task i and j (i,j ε L) is included in routing r ε R^{f} and timetabling p ε P^{t} respectively. Finally, S^{f} is the set of special connections of fleet f ε F. The integrated decision making problem can be expressed as (other formulations are possible too):

$$min c ( x , v ) + {\sum }_{t ∈ T} {\sum }_{p ∈ {P}^{t}} {c}_{p} {w}_{p} \qquad ( 1 a )$$

$$\begin{matrix}subject to {\sum }_{f ∈ Γ} {x}_{fl} = {b}_{l} , ∀ l ∈ L , & ( 1 b ) \\ x ∈ X , & ( 1 c ) \\ {x}_{fl} - {\sum }_{r ∈ {R}^{f}} {e}_{lr} {v}_{r} = 0 , ∀ l ∈ L , ∀ f ∈ F , & ( 1 d ) \\ {s}_{f}^{ij} - {\sum }_{r ∈ {R}^{f}} {s}_{r}^{ij} {v}_{r} = 0 , ∀ ij ∈ {S}^{f} , ∀ f ∈ F , & ( 1 e ) \\ {x}_{fl} - {\sum }_{p ∈ {P}^{t}} {a}_{lp} {w}_{p} = 0 , ∀ l ∈ L , ∀ f ∈ t , ∀ t ∈ T , & ( 1 f ) \\ {s}_{f}^{* ij} - {\sum }_{p ∈ {P}^{t}} {s}_{p}^{ij} {w}_{p} = 0 , ∀ ij ∈ {S}^{f} , ∀ f ∈ t , ∀ t ∈ T , & ( 1 g ) \\ {s}_{f}^{* ij} - {s}_{f}^{ij} \leq 0 , ∀ ij ∈ {S}^{f} , ∀ f ∈ F , & ( 1 h ) \\ {x}_{fl} ∈ IN , ∀ l ∈ L , ∀ f ∈ F , & ( 1 i ) \\ {v}_{r} ∈ \{ 0 , 1 \} , ∀ r ∈ {R}^{f} , ∀ f ∈ F , & ( 1 j ) \\ {w}_{p} ∈ \{ 0 , 1 \} , ∀ p ∈ {P}^{t} , ∀ t ∈ T , & ( 1 k )\end{matrix}$$

where X ⊂ N^{|L|×|D|} is the set of task assignment solutions according to some constraints (|·| gives the number of elements in a set), the details of which can be given in any form, even non-linear. An example of such constraints for airline scheduling is given by Hane et al. (1995). Finally, N is the set of natural numbers {0,1,2, . . . }. The structure of the above model is a commonplace in the references of the prior art, and equivalent forms can be easily attained.

The objective (1a), here, is minimizing the overall costs, while constraint (1b) ensures that exactly bₗ vehicles are assigned to each task l ε L, where bₗ are user specified constants. Constraint (1c) is given as a generic expression of constraints utilized for the task assignment. Constraints (1d) and (1f) ensure that the routing solutions of each fleet and the timetabling solutions of each family cover the tasks exactly as many times as they have been assigned to each fleet. With constraints (1e) and (1g) one obtains respectively the auxiliary variables s^{ij}_{f} and s*^{ij}_{f} which give the number of times the special connection of i with j (i,j ε L) is included in the routing and timetabling solution respectively, for fleet f ε F. Finally, constraint (1h) ensures that for each family the number of times crew are timetabled for a special connection is at most equal to the times this connection is performed by the vehicles.

In the above model an objective is given, by equation (1a). Notice, however, that this is provided as an example, since it is not always necessary for task assignment and resources scheduling to optimize some objective. Sometimes it is sufficient to obey the given constraints, i.e. (1b)-(1k). It is also possible to express mathematically a constraint satisfaction problem as an optimization problem with constant costs, which in the present case would be c(x,v):=0,∀x_{fl},∀vᵣ,∀l ε L,∀r ε R^{f},∀f ε F, and cₚ:=0,∀p ε P^{r},∀t ε T.

Model (1) was provided for ease of exposition. Notice that it can be possible to reduce the size of the model by eliminating constraints (1d), (1e) and (1g). These eliminations can be accomplished by: substituting x_{fl} in constraints (1b) and (1c) with the second term of equation (1d), substituting s^{ij}_{f} in constraint (1h) with the second term of equation (1e), and substituting s*^{ij}_{f} in constraint (1h) with the second term of equation (1g). For everything that follows assume that all of the above substitutions are accomplished except for the ones concerning variables x_{fl}.

As an example for the application of model (1), for airlines, exactly one aircraft has to be allocated for each flight, that is bₗ≡1,∀l ε L. Moreover, special crew connections concern the violation of the so called minimum sit-time. Minimum sit-time is the time typically needed by crew, after landing, to commute within the terminals of the airport and board on the aircraft of their next flight. If the next flight in their schedule is operated by the same aircraft, they will not have to commute, but will remain in the same aircraft. Hence, the crew and their flight will be able to depart at an earlier time than that designated by the minimum sit-time restriction. In terms of constraint (1h) it means that crew can violate the minimum-sit time (s*^{ij}_{f}=1) between flights i and j if and only if i and j are operated by the same aircraft (s^{ij}_{f}=1).

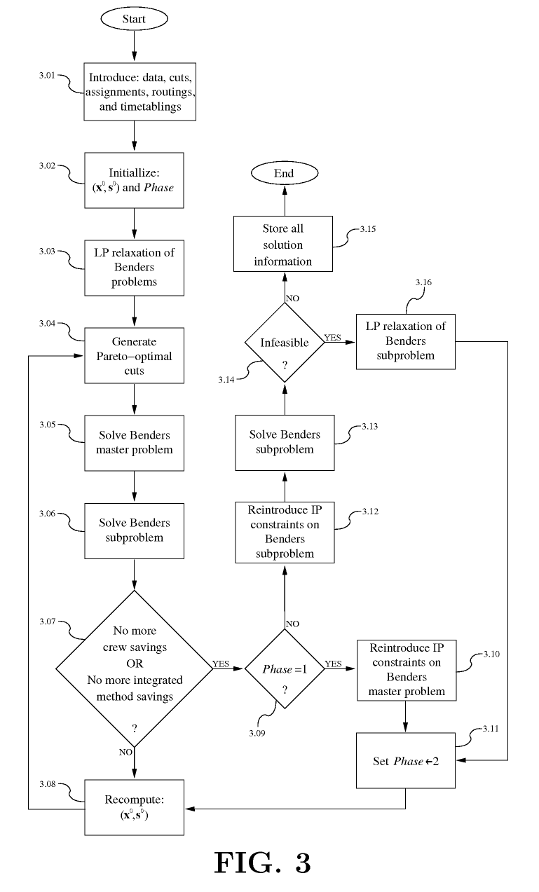

In one embodiment the integrated problem (1) is solved by a method provided in FIG. 3. Since the system is integrating all decision making problems, all corresponding data 1.06, 1.09, and 1.12, inputed by the user in the system, can simply be inputed in step 3.01 of the present method and be stored until needed.

The method provided in FIG. 3 makes task assignment decisions and scheduling decisions for a subset of the resources, in the form of a Benders master problem, in step 3.05. furthermore in step 3.06, the method makes decisions for the schedule of the resources not included in step 3.05, in the form of a Benders subproblem. Next in step 3.07 it is decided whether the decisions are of an acceptable quality. In one embodiment a solution is deemed acceptable if the constraints of the task assignment and all resources schedules are satisfied. In other embodiments it is also necessary to be within a predetermined distance from the optimal value. In some embodiments the distance from the optimal value is computed with the help of the upper bound and lower bound with the assistance of the Benders decomposition. If the decision is not of an acceptable solution a different decision needs to be made, and in one embodiment this is achieved by excluding the solutions achieved so far. In some embodiments different solutions are ensured by adding Benders cuts. In order to make Benders cuts as tight as possible one needs to generate Pareto-optimal Benders cuts, that also known simply as Pareto-optimal cuts.

Pareto-optimal cuts are generated in step 3.04 by the solution of an independent Pareto-optimal cut generation problem which for each family t ε T is:

$$\begin{matrix}min {\sum }_{p ∈ {P}^{t}} {c}_{p} {w}_{p} & ( 2 a ) \\ subject to {\sum }_{p ∈ {P}^{t}} {a}_{lp} {w}_{p} = {x}_{fl}^{0} , ∀ l ∈ L , ∀ f ∈ t & ( 2 b ) \\ {\sum }_{p ∈ {P}^{t}} {s}_{p}^{ij} {w}_{p} \leq {s}_{f}^{0 , ij} , ∀ ij ∈ {S}^{f} , ∀ f ∈ t & ( 2 c ) \\ {w}_{p} \geq 0 , ∀ p ∈ {P}^{t} , & ( 2 d )\end{matrix}$$

where the crucial point (x⁰,s⁰) needed above, with x⁰≡(x_{fl}⁰|∀l ε L,∀f ε F) and s⁰≡(s_{f}^{0,ij}|∀f ε F,∀ij ε S^{F}), is initialized in step 3.02 by:

x_{fl}⁰←bₗ, ∀l ε L,∀f ε F, (3a)

s_{f}^{0,jf}←min{x_{fi}⁰,x_{fj}⁰}, ∀ij ε S^{f},∀f ε F. (3b)

and where the point (x⁰,s⁰) is recomputed each time in step 3.08 by:

x_{fl}⁰←g·x_{fl}⁰+(1−g)· x̅_{fl}, ∀l ε L,∀f ε F, (4a)

s_{f}^{0,ij}←min{g·s_{f}^{0,ij}+(1−g)· s̅^{ij}_{f},min{x_{fi}⁰,x_{fj}⁰}}, ∀ij ε S^{f},∀f ε F, (4b)

where in the experiments the value g=½ was used (but other values can work efficiently too), and x̅≡( x̅_{fl}|∀l ε L,∀f ε F) and s̅≡( s̅^{ij}_{f}|∀f ε F,∀ij ε S^{f}) are respectively computed through equations (1d) and (1e), in which equations one needs to substitute x_{fl},s^{ij}_{f}, and vᵣ with x̅_{fl}, s̅^{ij}_{f}, and v̅ᵣ. The constants v̅ᵣ are the solutions of the Benders master problem solved in step 3.05:

$$\begin{matrix}min c ( x , v ) + {\sum }_{t ∈ T} {z}_{t} & ( 5 a ) \\ subject to {\sum }_{f ∈ F} {x}_{fl} = {b}_{l} , ∀ l ∈ L , & ( 5 b ) \\ x ∈ X , & ( 5 c ) \\ {x}_{fl} - {\sum }_{r ∈ {R}^{f}} {e}_{lr} {v}_{r} = 0 , ∀ l ∈ L , ∀ f ∈ F , & ( 5 d ) \\ - {z}_{t} + {\sum }_{f ∈ t} {\sum }_{r ∈ {R}^{f}} ( {\sum }_{l ∈ L} {α}_{l} {e}_{lr} + {\sum }_{ij ∈ {S}^{f}} {ς}^{ij} {s}_{r}^{ij} ) {v}_{r} \leq 0 , ∀ ( α , ς ) ∈ {\prod }_{points}^{t} , ∀ t ∈ T , & ( 5 e ) \\ {\sum }_{f ∈ t} {\sum }_{r ∈ {R}^{f}} ( {\sum }_{l ∈ L} {α}_{l} {e}_{lr} + {\sum }_{ij ∈ {S}^{f}} {ς}^{ij} {s}_{r}^{ij} ) {v}_{r} \leq 0 , ∀ ( α , ς ) ∈ {\prod }_{rays}^{t} , ∀ t ∈ T , & ( 5 f ) \\ {x}_{fl} ∈ IN , ∀ l ∈ L , ∀ f ∈ F , & ( 5 g ) \\ {v}_{r} ∈ \{ 0 , 1 \} , ∀ r ∈ {R}^{f} , ∀ f ∈ F . & ( 5 h )\end{matrix}$$

The constants α≡(αₗ|∀l ε L) and ζ≡(ζ^{ij}|∀ij ε S^{f}) are the dual solutions of the independent Pareto-optimal cut generation problem (2), and are obtained during step 3.04 or 3.06. Equations (3) are basically supplying the Pareto-optimal cut generation problem with maximal information stemming from the extreme case where all possible tasks will be assigned to the vehicles of fleet f only.

The previously mentioned problems (2) and (5) utilize the user input data stored in step 3.01 to construct the matrices aₗₚ,s^{ij}ₚ and eₗᵣ,bₗ respectively, and assign the respective costs cₚ and cost functions c(x, v).

Problem (2) is typically a linear programming (LP) problem, that is to say an optimization problem with linear objective, linear constraints expressed by equalities and inequalities, as well as variables constrained in real numbers intervals only. Depending on the structure of the matrix eₗᵣ, they can be solved using the simplex method or interior point methods. Since the main goal of step 3.04 is to acquire the dual values (α,ζ), one may in that step instead solve the dual of problem (2), and then directly extract the values (α,ζ) from the solution. In some application the matrix eₗᵣ has too many columns, and problem (2) is solved with column generation, wherefrom it is easy to extract the dual solutions (α,ζ) (Mercier et al., 2005). It is possible instead of solving problem (2) to optimality, to terminate with a quickly-reachable near-optimal solution. This can be achieved by employing a user defined acceptable gap (distance) from a lower bound, as for instance the Lasdon bound (Lasdon, 1970). The gap should be relatively small to avoid seriously influencing the strength of the introduced cut. In the experiments performed, the solution process was terminated when z−z^{LB}/z^{LB} was smaller than 10⁻⁴, where z is the cost of the current iteration and z^{LB} the lower bound. Other values may work well too, and it is up to the user to balance accuracy over efficiency by choosing the appropriate value.

The traditional technique of Magnanti and Wong (1981), generating Pareto-optimal cuts, requires a Benders master problem core point. Sandhu and Klabjan (2004) considered the task of finding such a core point as non trivial, and therefore avoided using that technique. Notice, however, that the point provided by initialization (4) is typically not even a Benders master problem point. This is because initialization (4) implies the assignment of all tasks l ε L to all fleets, which typically is not possible as the task assignment is solved in the first place to allocate scarce resources, that is a limited number of available vehicles. Although the point provided by initialization (4) is not a core point it does provide good cuts, and in many cases Pareto-optimal cuts Papadakos (2006, 2008). Since there are other points (x⁰,s⁰), that are not core points, which can give Pareto-optimal cuts through problem (2), one is using here a more generic term to characterize them, by calling them crucial points.

In step 3.06 the Benders subproblem is solved for each family, which for a specific family t ε T it is:

$$\begin{matrix}min {\sum }_{p ∈ {P}^{t}} {c}_{p} {w}_{p} & ( 6 a ) \\ subject to {\sum }_{p ∈ {P}^{t}} {a}_{lp} {w}_{p} = {\overline{x}}_{fl} , ∀ l ∈ L , ∀ f ∈ t & ( 6 b ) \\ {\sum }_{p ∈ {P}^{t}} {s}_{p}^{ij} {w}_{p} \leq {\overline{s}}_{f}^{ij} , ∀ ij ∈ {S}^{f} , ∀ f ∈ t , & ( 6 c ) \\ {w}_{p} ∈ \{ 0 , 1 \} , ∀ p ∈ {P}^{t} , & ( 6 d )\end{matrix}$$

where the constants x̅ and s̅ are the solutions passed directly to the Benders subproblem from step 3.05 the last time Benders master problem was solved. In step 3.03 the Benders subproblem (6) is LP relaxed by replacing constraint (6d) with wₚ≧0,∀p ε P^{t}. Therefore, in step 3.06 the LP relaxation of that problem is usually solved with the same method problem (2) is solved, due to their similarity. Based on this similarity, it is also usually a good idea to quickly terminate the solution of the Benders subproblem with a near-optimal solution as discussed earlier for the solution of problem (2). Furthermore, the same lower bound techniques used for problem (2), can be used for subproblem (6) too, and of course they can be of the same magnitude. The matrices aₗₚ and s^{ij}ₚ as well as costs cₚ used in problem (6) are those created for problem (2) utilizing the user input stored data from step 3.01. If column generation is used, it is always a good idea to store the columns generated, for a specific family, during steps 3.04 and 3.06, and pass these columns, after a filtering, to both steps next time they are executed. The filtering should primarily be executed to remove any columns that do not obey the constraints of the currently solved problem. For instance, given a solution ( x̅, s̅), several tasks or special connections may not exist for the family of a specific Benders subproblem, and any columns containing them should not be added.

If in step 3.04 problem (2) for family t ε T is feasible, then the values (α,ζ are added in the set Πₚₒᵢₙₜₛ^{t}, in constraint (5e) and hence it is said that an optimality cut is added. Otherwise, one adds the values (α,ζ) in the set Π_{rays}^{t}, used in constraint (5f) and hence it is said that a feasibility cut is added. If in step 3.06 problem (6) was infeasible the values (α,ζ) are also added in the set Π_{rays}^{t}. What happens in case problem (6) is feasible will soon be discussed. It should be stressed that in practice usually problem (6) is converted into an always feasible problem (Cordeau et al., 2001b). For this conversion, notice first that it is easy to calculate the maximum cost c_{max P} that any timetabling can attain. Based on this, one can insert in problem (6) artificial columns defined for each l ε L by:

$${a}_{\tilde{l} {p}_{l}} := \{ \begin{matrix}1 , & if l = \tilde{l} , \\ 0 , & otherwise ,\end{matrix} ∀ \tilde{l} ∈ L , \qquad ( 7 )$$

with cost cₚ_{ₗ}=c_{max P} respectively, where M is a number larger than one (i.e. 10³). The same conversion can be accomplished for problem (2) in step 3.04. In cases where the converted problems are used only optimality cuts need to be added.

The sets Πₚₒᵢₙₜₛ^{t} and Π_{rays} ^{t} are initialized in step 3.01, and one may start with both sets being empty. It is possible, however, to have some good initial starting points or rays for those sets. If the same problem has been solved previously using the present method, the old solution and cuts would have been stored in step 3.15, and it is therefore possible to re-use these old cuts and re-solve from the state the old problem was. Additionally, if the new problem is not identical to the old, it is possible to isolate the corresponding (α,ζ) and remove them from sets Πₚₒᵢₙₜₛ^{t} and Π_{rays}^{t}. As an example, assume that for some reason task l might be forbidden from being assigned to fleet f. In that case all dual values αₗ, ζ^{lj},∀lj ε S^{f}, and ζ^{il},∀il ε S^{f}, included in set Πₚₒᵢₙₜₛ^{l} for f ε t have to be removed.

It is also possible to add some initially good cuts by finding the appropriate dual values (α,ζ) in step 3.01, before the essential steps 3.04, 3.05, and 3.06 are executed. To achieve this, one can find the minimum cost c_{lt,min P} that each task l ε L will bring into any timetabling p ε P^{t} for every family t ε T, and one may add values αₗ=c_{lt,min P} in the sets Πₚₒᵢₙₜₛ^{t}. For instance, in the case of airlines there is typically a minimum payment c_{t,min fly} that crew of each family t ε T are guaranteed per flying hour, and if each flight l ε L has a duration of dₗₜ then c_{lt,min P}:=c_{t,min fly}·dₗₜ.

In step 3.07 it is decided whether more cuts have to be added, and if they must be added one proceeds with step 3.08. Otherwise, one proceeds with step 3.09. No more cuts need to be added: if the solution of Benders subproblem for every family will not significantly reduce the costs of crew timetabling, or if the savings due to the present method in comparison with other methods are satisfactory to the user.

In the first case, an optimality cut for a specific family t is generated when the ratio of the difference between the upper and lower bound of the Benders subproblem of that family, to the lower bound of the Benders master problem is more than a user defined tolerance, hₜ:

$$\frac{z ( {\overline{w}}_{{p}_{t}}^{i} ) - {z}_{t}}{{max}_{i} z ( {\overline{x}}^{i} , {\overline{v}}^{i} )} > {h}_{t} , \qquad ( 8 )$$

where z( w̅ₚ_{ₜ}ⁱ) and z( x̅ⁱ v̅ⁱ) are respectively the objective values of the crew timetabling problem (6) and of the Benders master problem (5), on the i-th Benders iteration. In step 3.02 the iteration counter i is initialized to 1, to mark that the first iteration is about to start, and in step 3.08 the iteration counter i is augmented by one. The constant hₜ is the user's desired fraction of the crew timetabling cost improvement of family t with respect to the overall cost that can be attained by adding more cuts. In step 3.04 it is not necessary to solve the independent Pareto-optimal cut generation problem (2) and add the corresponding cuts for all families. It saves more time to solve problem (2) only for the families t for which condition (8) holds, and if only the corresponding cuts are added problem (5) will contain less constraints and will probably be solved easier. Of course, the first time step 3.04 is executed (i=1) there is no information concerning condition (8). In that case, the problem (2) is solved for all families and all cuts are added.

Furthermore, the present method provides the advantage of being able to estimate the savings generated due to the integration and in comparison with the best known methods. Based on this estimate, it is possible to terminate the Benders algorithm when there are relatively small potential savings through any future iterations. The estimation is accomplished by observing that the solution of the Benders master problem on the first iteration corresponds to that of a sequential method, due to the absence of Benders cuts (5e) and (5f) (Πₚₒᵢₙₜₛ^{t}=Π_{rays}^{t}=). In that sequential method the integrated task assignment with vehicle routing problem is followed by the solution of each crew timetabling with special connections problem. The potential savings that can be generated through the rest of the iterations are given by the sum of the differences between the upper and lower bounds of the crew timetabling problems of each family. The condition that needs to hold in order to continue the Benders iterations in the present case is:

$$\frac{{\sum }_{t ∈ T} [ z ( {\overline{w}}_{{p}_{t}}^{i} ) - {z}_{t} ]}{{z}^{Seq} - z ( {\overline{x}}^{1} , {\overline{v}}^{1} )} > h , \qquad ( 9 )$$

where z^{Seq}:=c( x̅¹, v̅¹)+Σ_{tε′l′ Σ}_{pεP}_{^{t}} cₚ w̅ₚ¹ is the integrated cost of the first iteration obtained by objective (1a), and h is a user defined constant. The tolerance h is the user's desired least expected ratio of potential savings in overall crew costs to the actual crew costs due to the above described sequential method.

For some applications, in step 3.02 the Phase variable is initialized to 1 (see Mercier et al. (2005) and references therein for the three-phase method), and in step 3.03 the Benders master problem (5) is LP relaxed by replacing constraint (5g) with x_{fl}≧0,∀l ε L,∀f ε F, and constraint (5h) with vᵣ≧0,∀r ε R^{f},∀f ε F. Thus if Phase=1 in step 3.05 the LP relaxation of problem (5) can be solved by using the simplex method, an interior point method or column generation (Barnhart et al., 1998a). These methods are used under the assumption that the objective (5a) and constraints (5c) are linear too; otherwise a non-linear method should be used. The problem does not have to be solved to optimality, and user defined acceptable gaps (distances) from optimality can be employed in a similar manner that this was done for the solution of problems (2) and (6). In addition to the lower bounds estimations used for problems (2) and (6), one can store and employ the lower bounds from all previous times step 3.05 was executed, and use as a lower bound in the computation of the acceptable gap the maximum of: all lower bounds from all previous iterations and the one estimated in the current iteration.

In step 3.09 if Phase=1, then one proceeds with step 3.10 where the IP constraints (5g) and (5h) are reintroduced in Benders master problem (5), and then one proceeds with step 3.11 where Phase←2 is set. IP stands for Integer Programming, that is an LP problem where some variables are restricted to discrete sets, i.e. integers.

In step 3.02, in the experiments performed, one sets Phase←1, hₗ←10⁻⁴, and h←⅛. In step 3.11 one sets Phase←2, hₜ←10⁻³, and h← m1/2. All these values are given only as an example, as other values work well too, and it is up to the user to select the appropriate values balancing efficiency over accuracy.

In step 3.05 if Phase=1, one solves the IP Benders master problem (5), which is typically solved with branch-and-bound—if simplex method is employed for the LP relaxation—or branch-and-price (see e.g. Barnhart et al. (1998a) or Mercier et al. (2005))—if column generation is employed for the LP relaxation. One efficient solution search method is depth-first where additionally one terminates with the first feasible solution of the IP problem. It is also possible to have a restricted number of nodes searched in the branch-and-bound or branch-and-price method, or alternatively employ a best-first search method. It can also be a good idea to use a quick evaluation of all candidate branches. For this evaluation, one may quickly solve, for each candidate branch, the task assignment problem alone. For even quicker results, one can also solve its LP relaxation. Based on this evaluation, one can sort the branches in order of expected cost, and choose first those that are expected to have the lowest cost. Additionally, if the task assignment evaluation has no solution for a branch, it clearly implies that the full Benders master problem, containing task assignment, will have no solution either. This prunes that branch, limits the search space, and hence speeds-up the solution process. In order to reduce the search effort, one can always have an incomplete search method, where the search finishes after a given number of feasible solutions found.

If in step 3.09 Phase=2, then one proceeds with step 3.12 where constraint (6d) is reintroduced in Benders subproblem (6). After this, in step 3.13 the IP version of Benders subproblem (6) is solved, following the ideas described in the previous paragraph for the IP solution of the Benders master problem. One may also employ the techniques of Mercier et al. (2005).

In step 3.14 if the solution of the IP Benders subproblem (solved in step 3.13) was feasible for all families, then one proceeds with step 3.15 where one acquires the integrated optimal solution of crew timetabling, as well as the task assignment and vehicle routing solution from the Benders master problem processed the last time the method was in step 3.05. Furthermore, in step 3.15 all information produced during the solution is stored: the cuts generated and kept in sets Πₚₒᵢₙₜₛ^{t} and Π_{rays}^{t}, and the lower and upper bounds found while solving all Benders problems in steps 3.05, 3.06, and 3.12. Finally, whenever column generation is employed, it is beneficial storing the columns generated, as they could be re-used in the future by reintroducing them in step 3.01. Therefore step 3.15 serves to store all solution information in a similar manner step 1.16 did for the process provided in FIG. 1, and additionally to store the necessary information that could be re-used in the future.

Otherwise, if in step 3.14 the solution of some of the IP Benders subproblems (solved in step 3.13) was infeasible, then one proceeds with step 3.16 where the Benders subproblem (6) is LP relaxed by replacing constraint (6d) with wₚ≧0,∀p ε P^{t}. After this, the procedure returns in step 3.11 where Phase←2 is set.

In step 3.01 it is typically useful to introduce known solutions of the task assignment, vehicle routing, and crew timetabling. For instance, when column generation is employed, one may solve ahead the vehicle routing problem and then the crew timetabling for each individual family, and pass these columns to the Benders master problem and Benders subproblem respectively. As explained earlier, in step 3.01 one may re-use old solutions to solve a modified new problem, i.e. reintroduce columns generated by the old problem. In such cases the task assignments, the vehicle routings, and the crew timetabling which do not comply with the modifications have to be removed. For instance, if task l is forbidden from being assigned to fleet f, all routings r ε R^{f} and all timetablings p ε P^{t} that include that task should not be added. If the vehicle routing and task assignment part of the re-solved problem is unmodified, it also possible to re-use the lower bounds of the old problem, by introducing them in step 3.01.

If column generation is employed for the solution of the Pareto-optimal cut generation problem (2), it is not necessary to introduce those constraints (2b) for which x_{fl}⁰=0 and those constraints (2c) for which s_{f}^{0,ij}=0. In such cases, the tasks for which x_{fl}⁰=0 and the special connections for which s_{f}^{0,ij}=0 have to be removed from the column generation subproblem. The latter subproblem is usually made of a network, and hence the respective nodes and arcs have to be eliminated. The same eliminations in the constraints and the column generation subproblem can also be implemented for the solution of Benders subproblem (6), if x̅_{fl}=0 for constraint (6b) and if s̅^{ij}_{f}=0 for constraint (6c). In all previous cases, the equality “=0” can be numerically considered up to a tolerance. More specifically, if any constant or variable is smaller than 10⁻⁵ (other values can be efficient too) then it will be considered as equal to zero.

Once reaching step 3.15, the Benders master problem will contain an integer solution, and for each task l ε L variables x_{fl}=1 will be indicating the number of vehicles of each fleet f ε F that are proposed by the method to be assigned to task l. Similarly, the integer solution of vehicle routing (here in the Benders master problem) will have a variable vᵣ=1,r ε R^{f}, for each fleet f ε F, indicating that that routing is proposed by the method. Finally, in the Benders subproblem there will be a variable wₚ=1,p ε P^{t}, for each family t ε T, indicating that timetabling p is proposed by the method.

Summing up, according to one embodiment, the procedure of the present invention as shown in FIG. 3 works as follows: it starts with step 3.01 where the user defined data is inputed, together with possibly some data concerning cuts, assignments, routings, and timetablings; then in step 3.02 Phase and (x⁰,s⁰) are initialized; then in step 3.03 the Benders subproblem is LP relaxed and if Phase=1 the Benders master problem is LP relaxed too; then in step 3.04 Pareto-optimal cuts need to be generated—based on the given (x⁰,s⁰)—for all families, if we are in the first Benders iteration, otherwise for the families that condition (8) was true; then in step 3.05 the Benders master problem is solved and the solution ( x̅, s̅) is then passed to step 3.06 where the Benders subproblem is solved for all families; then in step 3.07 if either condition (8) doe not hold for all fleets or condition (9) does not hold, one proceeds with step 3.09, otherwise one proceeds with step 3.08; in step 3.08 one recomputes (x⁰,s⁰) and then returns to step 3.04; in step 3.09 if Phase=1, one continues with step 3.10, otherwise one continues with step 3.12; in step 3.10 the IP constraints are reintroduced on the Benders master problem; then one continues with step 3.11 where one sets Phase←2 and returns to step 3.08; in step 3.12 the IP constraints are reintroduced on the Benders subproblem, which is then solved in step 3.13; then in step 3.14 if the solution of the Benders subproblem for any family was infeasible one proceeds with step 3.16, otherwise one finishes with step 3.15 where all solutions are acquired and solution information that could be re-used is stored; in step 3.16 the Benders subproblem is LP relaxed, and then one continues with step 3.11.

The advantages of the above method for airlines are discussed by Papadakos (2006, 2007). There, it is reported that cost savings of a magnitude around 2% can be achieved in comparison to the best available method, which is that of Barnhart et al. (1998a) sequentially followed by the method of Mercier et al. (2005). For an airline with 6 fleets and up to 700 flights this translates into 24 millions US dollars per year. Moreover, the integrated method simultaneously ensures feasibility of task assignment and resources scheduling problems. Additionally, the information stored in step 3.15 helps the method, by supplying good initial information in step 3.01 in any future instance a similar problem is solved, thereby increasing the efficiency of that future solution.

It should be readily apparent to those skilled in the art, Operations Research, that many modifications and adaptations are possible.

For example, one could change the execution order of steps 3.04, 3.05, and 3.06. This variation involves step 3.03 being directly connected with step 3.05 instead of 3.04. Thus after step 3.03, step 3.05 should be executed. Additionally, in that case in all iterations one could use the information of condition (8) to decide for which families the Pareto-optimal cut generation problem (2) needs to be solved and the corresponding cuts need to be added. This variation is useful when step 3.04 is tedious or not many iterations are typically expected.

It is also possible, instead of solving the proposed independent Pareto-optimal cut generation problem (2) in step 3.04, to solve the following problem (similar to the one of Mercier et al. (2005)):

$$\begin{matrix}min {\sum }_{p ∈ {P}^{t}} {c}_{p} {w}_{p} + z ( {\overline{w}}_{p} ) ζ & ( 10 a ) \\ subject to {\sum }_{p ∈ {P}^{t}} {a}_{lp} {w}_{p} + {\overline{x}}_{fl} ζ = {x}_{fl}^{0} , ∀ l ∈ L , ∀ f ∈ t & ( 10 b ) \\ {\sum }_{p ∈ {P}^{t}} {s}_{p}^{ij} {w}_{p} + {\overline{s}}_{f}^{ij} ζ \leq {s}_{f}^{0 , ij} , ∀ ij ∈ S , ∀ f ∈ t & ( 10 c ) \\ {w}_{p} \geq 0 , ∀ p ∈ {P}^{t} , & ( 10 d )\end{matrix}$$

where z( w̅ₚ) is the optimal solution of the Benders subproblem, which was solved given the last Benders master problem solution x̅_{fl} and s̅^{ij}_{f}. Since the latter solution needs to be obtained in order to solve problem (10), one needs to change the order by which the steps of the algorithm are executed, as described in the previous paragraph. Notice that problem (10) corresponds to the dual of the Pareto-optimal cut generation problem introduced by Magnanti and Wong (1981). One important disadvantage of model (10) is that it needs the optimal Benders subproblem solution in the objective function (10a). This is a disadvantage as it is not possible to terminate the solution of the Benders subproblem earlier with a quick near-optimal solution increasing the inefficiency of the overall procedure. It was additionally shown, by Papadakos (2006, 2008), that if a suboptimal solution is used instead, problem (10) becomes numerically unbounded. Of course notice that the independent model (2) acquires its name from the fact that it is independent of the Benders subproblem solution, therefore tackling this issue. It is also possible to solve the dual of problem (10) instead, i.e. when column generation is not employed.

In step 3.02 instead of the initializations (3) it is possible to use initializations that can give approximate core points. Such approximations can be acquired by employing a task assignment model—for airlines one may use for instance that of Hane et al. (1995)—and quickly find a solution x_{fl}⁰,∀l ε L,∀f ε F. In fact in order to speed-up the solution process it is typically better to solve the LP relaxation of the task assignment problem. It can also be a good idea to prevent the variables x_{fl} from taking any integer values, which would approximate the notion of a core point even better. It is also possible instead of the recomputation equation (4b) to use s_{f}^{0,ij}←min{x_{fi}⁰,x_{fj}⁰},∀ij ε S^{f},∀f ε F.

Another variation is employed in cases where the IP Benders problem is not very difficult to be solved; then one may start in step 3.02 by setting Phase←2 instead of 1, and then in step 3.03 not LP relax the Benders master problem but only the subproblem.

It is also possible to apply Benders decomposition on model (1) in different variations. One may for instance have constraint (1d) in the Benders subproblem instead of constraint (1f), and in that case the same substitution should be performed in the Pareto-optimal cut generation problem. Because of these substitutions instead of the variables s^{ij}_{f},∀ij ε S^{f},∀f ε F, one will use s*^{ij}_{f},∀ij ε S^{f},∀f ε F. For these cases, instead of initialization (3b) it is sometimes better setting s*^{0,ij}_{f}←0,∀ij ε S^{f},∀f ε F. In this decomposition, it is better—although not necessary—starting the method by setting Phase←2 in step 3.03, as described in the previous paragraph. It is also possible to have task assignment in the Benders subproblem too, while some or all of the resources scheduling problems will be in the Benders master problem. It is also possible to use different formulations from those provided in model (1).

One may also employ any of the methods, previously provided, to solve restricted integrated problems, like the integrated task assignment with vehicle routing problem (i.e. by setting wₚ=0,∀p ε P^{t},∀t ε T, and placing constraint (1d) in the Benders subproblem instead of constraint (1f) as explained in the previous paragraph), the integrated task assignment with crew timetabling (i.e. by setting vᵣ=0,∀r ε R^{f},∀f ε F), or the integrated vehicle routing with crew timetabling problem (i.e. by setting x_{fl}=0,∀l ε L,∀f ε F, and restricting that problem to each specific fleet with set F containing a single element, |F|=1). The restricted integration of task assignment with vehicle routing can be also used for the solution of the Benders master problem (5), therefore applying the present method in a nested form. Notice, that an important feature of integrating vehicle routing with crew timetabling is the Pareto-optimal cut generation problem (2), which allows near-optimal solution of Benders subproblem (6) in a column generation environment contrary to the traditionally used problem (10) (Magnanti and Wong, 1981, Mercier et al., 2005).

As discussed above, task assignment was combined with the scheduling of two resources. This was merely an example. The nested application of the present method, discussed in the previous paragraph, can be used generically to schedule more than these resources. This can be achieved recursively. Assume that one is given n resources R₁, . . . ,Rₙ to schedule in combination with task assignment. Then method M₁ is the integration of task assignment with resource R₁ scheduling, as already explained. Then method M₂ is the integration of method M₁ with resource R₂, as already explained too, etc.

One may insert further variables and constraints to incorporate additional features. For instance, one may add variables for restricted connections in constraint (1h), as Mercier et al. (2005) did, to enhance robustness of airline crew scheduling. One may enhance the vehicle routing information by including other auxiliary constraints such as the plane-count constraints of Sandhu and Klabjan (2004) or the ones of Papadakos (2006, 2007).

It is also possible to separate crew in different categories (e.g. pilots and air-hosts) and solve different problems for each category in steps 3.04, 3.06, and 3.13. That would also need separate z_{f} variables in the Benders master problem (5), for each different category.

Additionally, notice that steps 3.04, 3.06, and 3.13 involve the solution of different problems for each family. It would be therefore more efficient to solve each problem for each family on different processors or computers in parallel. Similar parallelizations could be used in step 3.05 if column generation is employed, where the column generation subproblem for each fleet could be solved in different processors or computers too.

Moreover, it is possible to use different termination conditions from those defined by equations (8) and (9). As an example, one can define termination conditions depending on the difference of the upper and lower bounds (Mercier et al., 2005) or after a predefined number of iterations (Sandhu and Klabjan, 2004), or execution time.

As already mentioned, the method and system described here are not restricted to its applications in transportation problems, and vehicles may be interpreted as any machine that can accomplish a task and crew any kind of operators of machines. It is also possible to schedule the machines exclusively (i.e. unmanned vehicles), or schedule the crew exclusively when they are working without operating any machine. One should interpret machines or operators as any type of resources that need to be scheduled.

Notice also, that due to the poor results reported by Sandhu and Klabjan (2004) when they applied Benders decomposition, the useful Benders decomposition method provided by the present invention also applies to the integration of task assignment with scheduling of crew only, and not including any other resources as for example aircraft scheduling. Likewise it is also applies to the integration of task assignment with scheduling of aircraft only, and not including any other resources as for example crew scheduling.

While the present method and system have been described in connection with preferred embodiments, many additional modifications will be readily apparent to those skilled in the art, Operations Research, and this application intended to cover any adaptations or variations thereof. This invention should be only limited by the claims and equivalents thereof.

What is claimed is:

1. A computer-implemented method for integrated task assignment decisions and resources scheduling decisions, comprising:
deciding an assignment of a task to each of the said resources based on a set of constraints,
for each scheduled resource, deciding a schedule of the said scheduled resource based on a given task assignment decision, on a given schedule decision for each of the other resources the said scheduled resource may depend on, and on a set of constraints, and
computing an integrated decision comprising:
a decision for the assignment of a task to each of the said resources, wherein no constraints are violated,
for each scheduled resource, a decision of the schedule of the said scheduled resource that was based on the said integrated decision's:
task assignment decision, and
scheduling decision of the resources that the said scheduled resource depends on,
wherein, if any constraints are violated, making different decisions on some or all of the following:
the tasks assigned,
the resources that the said scheduled resource depends on,
wherein said different decisions are made until no constraints of the said resource are violated.

2. The method of claim 1 wherein given an integrated decision the method additionally comprises:
computing a cost associated with each of the said decisions and computing a cost associated with the given integrated decision,
deciding whether it is possible to find a better integrated decision, wherein said better integrated decision is an integrated decision different from the given integrated decision with an associated cost not greater than the cost associated with the given integrated decision,
finding an integrated decision different from the given integrated decision,
deciding whether the given integrated decision is of an acceptable quality, where the user of the method determines the acceptability of: the given integrated decision, the cost associated with the given integrated decision, and the possibility of finding an integrated decision better than the given, and
finding a different integrated decision until the said quality is acceptable.

3. The method of claim 2 wherein mathematical models are used for both the task assignment decisions and the resources scheduling decisions, and a Benders decomposition method is used to decompose the integrated mathematical model of all decisions, wherein:
the said task assignment decisions and the said scheduling decisions of a subset of the resources are made in a Benders master problem, wherein said subset of resources may be empty,
the said scheduling decisions of the resources not included in the said Benders master problem are made in a Benders subproblem,
computing an upper bound and a lower bound for the associated cost of an integrated decision, and if the said upper bound and said lower bound are equal then it is not possible to get a better integrated decision,
the said quality acceptability is based on the gap between the said upper bound and the said lower bound, wherein an integrated decision is deemed acceptable if the said gap is smaller than a value predetermined by the user, and
wherein said different decisions are realized by computing and adding Benders cuts on the said Benders master problem.

4. The method of claim 3 further including computing an upper bound and a lower bound for each of the resources in the Benders subproblem, and wherein said quality acceptability is also able to be based on the gap between the upper bound and the lower bound of each of the resources on the Benders subproblem, wherein the said gaps are within a user predefined values.

5. The method of claim 4 wherein computing and adding Benders cuts that are Pareto-optimal, wherein a Benders cut is Pareto-optimal if it is tighter than any other Benders cut that could have been computed by the Benders subproblem with the same Benders subproblem cost as the Pareto-optimal cut.

6. The method of claim 5 wherein the said Pareto-optimal cuts are computed by solving a mathematical model that is independent of the said Benders subproblem decisions, thereby allowing a quick solution of the Benders subproblem, where said solution is allowed to be suboptimal.

7. The method of claim 6 wherein the said Pareto-optimal cuts for each resource are computed in conjunction with the maximal information stemming from the extreme case where all possible tasks would have been assigned to the said resource.

8. The method of claim 7 wherein predetermined cuts are added to the Benders master problem in the beginning.

9. The method of claim 8 wherein the said predetermined cuts are based on a previous solution.

10. The method of claim 9 wherein the said tasks are flights, and the said resources are aircraft and crew.

11. A system making integrated task assignment decisions and resources scheduling decisions, to be used in a computer system, comprising:
means for deciding an assignment of a task to each of the said resources based on a set of constraints,
for each scheduled resource, means for deciding a schedule of the said scheduled resource based on a given task assignment decision, on a given schedule decision for each of the other resources the said scheduled resource may depend on, and on a set of constraints, and
means for computing an integrated decision comprising:
a decision for the assignment of a task to each of the said resources, wherein no constraints are violated,
for each scheduled resource, a decision of the schedule of the said scheduled resource that was based on the said integrated decision's:
task assignment decision, and
scheduling decision of the resources that the said scheduled resource depends on,
wherein, if any constraints are violated, making different decisions on some or all of the following:
the tasks assigned,
the resources that the said scheduled resource depends on,
wherein said different decisions are made until no constraints of the said resource are violated.

12. The system of claim 11 wherein given an integrated decision the system additionally comprises:
means for computing a cost associated with each of the said decisions and means for computing a cost associated with the given integrated decision,
means for deciding whether it is possible to find a better integrated decision, wherein said better integrated decision is an integrated decision different from the given integrated decision with an associated cost not greater than the cost associated with the given integrated decision,
means for finding an integrated decision different from the given integrated decision,
means for deciding whether the given integrated decision is of an acceptable quality, where the user of the method determines the acceptability of: the given integrated decision, the cost associated with the given integrated decision, and the possibility of finding an integrated decision better than the given, and
means for finding a different integrated decision until the said quality is acceptable.

13. The system of claim 12 wherein mathematical models are used for both the task assignment decisions and the resources scheduling decisions, and a Benders decomposition method is used to decompose the integrated mathematical model of all decisions, wherein:
the said task assignment decisions and the said scheduling decisions of a subset of the resources are made in a Benders master problem, wherein said subset of resources may be empty,
the said scheduling decisions of the resources not included in the said Benders master problem are made in a Benders subproblem,
means for computing an upper bound and a lower bound for the associated cost of an integrated decision, and if the said upper bound and said lower bound are equal then it is not possible to get a better integrated decision,
the said quality acceptability is based on the gap between the said upper bound and the said lower bound, wherein an integrated decision is deemed acceptable if the said gap is smaller than a value predetermined by the user, and
wherein said different decisions are realized by means for computing and adding Benders cuts on the said Benders master problem.

14. The system of claim 13 further including means for computing an upper bound and a lower bound for each of the resources in the Benders subproblem, and wherein said quality acceptability is also able to be based on the gap between the upper bound and the lower bound of each of the resources on the Benders subproblem, wherein the said gaps are within a user predefined values.

15. The system of claim 14 wherein said means for computing and adding Benders cuts that are Pareto-optimal, wherein a Benders cut is Pareto-optimal if it is tighter than any other Benders cut that could have been computed by the Benders subproblem with the same Benders subproblem cost as the Pareto-optimal cut.

16. The system of claim 15 wherein the said Pareto-optimal cuts are computed by solving a mathematical model that is independent of the said Benders subproblem decisions, thereby allowing a quick solution of the Benders subproblem, where said solution is allowed to be suboptimal.

17. The system of claim 16 wherein the said Pareto-optimal cuts for each resource are computed in conjunction with the maximal information stemming from the extreme case where all possible tasks would have been assigned to the said resource.

18. The system of claim 17 wherein predetermined cuts are added to the Benders master problem in the beginning.

19. The system of claim 18 wherein the said predetermined cuts are based on a previous solution.

20. The system of claim 19 wherein the said tasks are flights, and the said resources are aircraft and crew.
